(19) United States
(12) Patent Application Publication
(10) Pub. No.: US 2025/0381694 A1
(43) Pub. Date: Dec. 18, 2025

(54) Method For Detecting Hair Cutting Events During Use Of A Wet Shaver And Wet Shaver

(71) Applicant: Braun GmbH, Kronberg (DE)

(72) Inventor: Christian Neyer, Eschborn (DE)

(21) Appl. No.: 19/234,691

(22) Filed: Jun. 11, 2025

(30) Foreign Application Priority Data
Jun. 12, 2024 (EP) 24181612.3

(51) Int. Cl. B26B 21/40; B26B 21/52

(52) U.S. Cl. CPC B26B 21/4056; B26B 21/4081; B26B 21/526

(57) ABSTRACT

The present invention relates a method for detecting hair cutting events during use of a wet shaver by measuring an acceleration and/or rotation sensor signal caused by a cut hair and by detecting a specific shape or pattern of said sensor signal and a wet shaver performing this method.

### FIELD OF THE INVENTION

The invention relates to a method for detecting hair cutting events during use of a hair removal device, especially a wet shaver. The invention also relates to a hair removal device, especially a wet shaver, which can detect hair cutting events during its use. Such devices are household appliances used in daily life.

### BACKGROUND OF THE INVENTION

The EP 0 719 202 B1 discloses a shaving apparatus with at least one cutting unit which is provided with an external cutting member with at least one hair trap opening and an internal cutting member which can be driven relative to the external cutting member by an electric motor, the motor having a speed which is controllable by means of an electrical control unit. The apparatus comprises at least one transducer, and an electrical control unit is proposed as a feedforward control unit which varies the motor speed in accordance with a predetermined control rule as a function of at least one physical quantity which is measurable by means of said transducer. The physical quantity measured by means of the transducer is a quantity which changes during a shaving operation and which affects the shaving performance, shaving comfort, and power consumption. For measuring a number of hairs cut by the cutting unit per unit time, the transducer is provided with a microphone capable of detecting an acoustic signal produced by the cutting unit. Another transducer is capable of measuring a skin contact force exerted on the cutting unit, the detector being a usual strain gauge sensor. However, for the measurements many different transducers or sensors are required. These are expensive and need extra space in the device.

### SUMMARY OF THE INVENTION

It is an object of the invention to provide a possibility for detecting hair cutting events during use of a hair removal device, in particular a wet shaver, with one simple sensor. It is a further object of the invention to utilize the signal pattern obtained by the detection method in order to extract useful information related to the hairs being cut as well as information related to the wet shaver (razor).

The above object is addressed by a method having the features of claim 1 and by a wet shaver having the features of claim 7. Advantageous further features are set forth by the subclaims.

Accordingly, a method for detecting hair cutting events during use of a wet shaver comprises measuring an acceleration and/or rotation sensor signal caused by a cut hair and by detecting a specific shape or pattern of said sensor signal.

A wet shaver with a hair cutting unit, comprises an acceleration and/or rotation sensor used to detect the hair cutting events of a wet shaver, wherein the acceleration and/or rotation sensor is adapted to detect in a measured acceleration and/or rotation sensor signal the shape or pattern of the signal.

For detecting hair cutting events, an acceleration and/or rotation sensor signal is measured during use of the wet shaver. When the blade of the wet shaver is cutting a hair, a deceleration of the wet shaver and/or rotation of the wet shaver is detected in the measured signal caused by hair cutting compared to a zero signal indicating no acceleration or deceleration and/or rotation of the wet shaver, and after the hair has been cut (meaning immediately after the blade of the wet shaver cutting the hair), an acceleration and/or rotation opposite to the first one of the wet shaver (compared to said zero signal of the wet shaver) is detected, and after some relaxation time, an acceleration and/or rotation signal, which goes back to said zero signal, is detected in said measured sensor signal.

The invention further provides a hair removal device, especially a wet shaver, comprising an acceleration and/or rotation sensor adapted (used) to detect the hair cutting events of a wet shaver. The sensor is adapted to detect a deceleration and an acceleration and/or a rotation of the wet shaver as described before. In over words, the sensor is adapted to perform the method as described before or parts thereof.

### BRIEF DESCRIPTION OF THE DRAWINGS

FIG. 1 shows a sketch of a wet shaver with an acceleration sensor during its use according to a proposed embodiment of the invention.

FIG. 2 shows an enlarged view of the circled part of FIG. 1 and illustrates the forces which occur when the blade of the wet shaver in FIG. 1 cuts a hair.

FIG. 3 shows a sketch of a wet shaver with a rotation sensor during its use according to a proposed embodiment of the invention.

FIG. 4 shows an enlarged view of the circled part of FIG. 3 and illustrates the force and the torque which occur when the blade of the wet shaver in FIG. 3 cuts a hair.

FIG. 5 shows the acceleration and the rotation of the wet shaver as function of time in the different phases around the cutting of a hair.

### DETAILED DESCRIPTION OF THE INVENTION

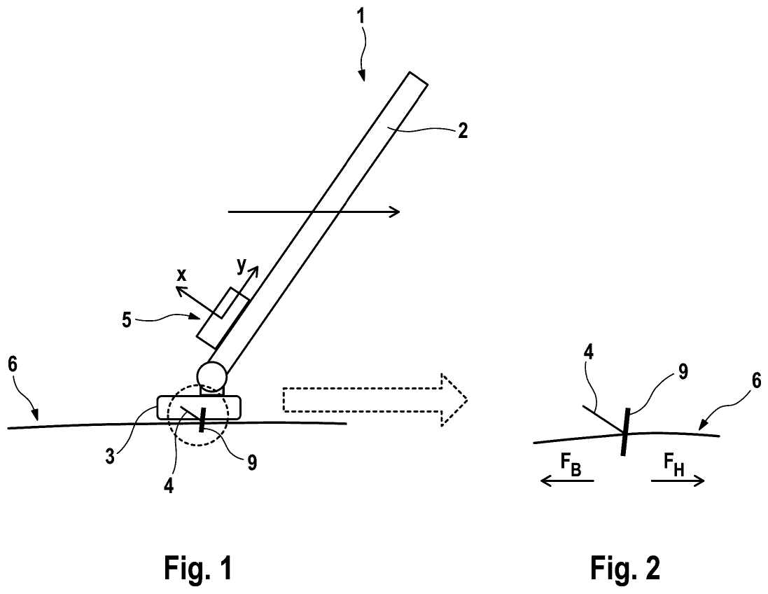

Before describing an advantageous embodiment of the invention related to the FIGS. 1 to 5, different aspects of the invention are described more in detail. These aspects disclose further features, advantages and possibilities of use of the present invention that might be combined in any useful combination. All features described and/or shown in the drawings are subject matter of the invention, irrespective of the grouping of the features in the claims and/or their back references.

The invention is described with reference to a wet shaver as hair removal device. Accordingly, in the below description, the terms “wet shaver” and “razor” are used synonymously and are interchangeable. The term “hair cutting unit” is to be understood as a “hair removal unit” for cutting and/or tearing out hairs. The term “hair cutting events” is to be understood as “hair removal” or “hair tearing out” events. The term “negative acceleration” and the term “acceleration with negative sign” are interchangeable and are to be understood as deceleration. The terms “positive acceleration”, “acceleration with positive sign” and “acceleration” are interchangeable.

When a wet shaver cuts a hair, the following events occur sequentially:

First, the blade of the wet shaver arrives at a hair and forms contact with the hair.

Then, a certain amount force, which is needed to cut the hair, is then applied to the blade. As a result, a negative acceleration (acceleration with negative sign), namely deceleration, occurs to the whole wet shaver. A rotation by a small angle happens as well. Such a rotation is experienced by every object that receives a force outside of its center of mass, given that the object is not hold completely tight, which would compensate or absorb any external forces.

As soon as the hair is cut, i.e. immediately after the blade of the wet shaver cutting the hair, the deceleration force disappears, and the razor regains its original velocity. In this time period, acceleration takes place. The acceleration is with positive sign, which is different from the signal from the deceleration (having a negative sign and acceleration).

After some relaxation time, the signal goes back to zero, meaning that the razor is moving with constant velocity. Only some noise remains which results from small accelerations or decelerations due to potentially fluctuating friction of the blade or blades on the skin. A zero signal in the sense of this description might comprise noise in its signal, i.e. showing small accelerations or decelerations which are however not due to hair cutting events and are thus neglected.

When the blade arrives at the next neighboring hair and forms contact, the above-mentioned events occur again sequentially. This circle repeats itself for each hair being cut.

The behavior of the wet shaver with respect to a rotation of the wet shaver due to the blade of the shaver cutting a wet hair is qualitatively similar or identical.

The process of acceleration with negative and positive sign (acceleration and deceleration) and/or rotation of the wet shaver is explained more in detail in the following: During the cutting of a hair, different accelerations are detected. The accelerations can be detected by using a micro electromechanical device (MEM), such as a commercially available acceleration sensor. The accelerations (both, with positive and negative signs) are present beside the acceleration of gravity. The acceleration of gravity is a contribution that is measured as an almost constant contribution during the cutting of a hair. This is not further discussed here. The following can be said about the other contributions that are detected by an acceleration sensor. They result from changes in velocity:

When a blade of the wet shaver is cutting a hair, first an acceleration against the movement of the wet shaver is detected. This happens because the blade is stopped or at least decelerated as soon as it touches a hair. This acceleration can be called negative acceleration (deceleration). In the moment when the hair is cut, an acceleration in the direction of the movement is detected. It can also be called positive acceleration. This happens because the mechanical resistance of the hair doesn't exist anymore in this moment, and the wet shaver regains its original velocity. After some relaxation time, the acceleration goes back to zero. The acceleration sensor doesn't measure any acceleration anymore, (apart from the acceleration of gravity and noise signals already discussed).

Instead of an acceleration sensor, a rotation sensor, such as a commercially available rotation sensor, can be used as well. Since any acceleration of the wet shaver outside of its center of gravity results also in a rotation of the whole razor, a detection of a rotation is an alternative to the detection of an (linear) acceleration. A potential advantage of a rotation sensor is that there is no contribution from the acceleration of gravity. The signal shape of the rotation sensor is qualitatively identical to the one from an acceleration sensor.

The method for detecting hair cutting events during use of a wet shaver according to the proposal detects the deceleration (acceleration with negative sign in the direction of movement) and/or rotation of the wet shaver when the blade of the wet shaver is cutting a hair, due to the force acting on the blade when the blade comes in contact with the hair. As soon as the hair is cut, i.e. directly after the wet shaver has cut the hair, an acceleration with positive sign (acceleration in the direction of movement) and/or a rotation opposite to the first one of the wet shaver is detected. After some relaxation time, a signal, which goes back to the zero signal (possible including some noise signals), is detected.

When there exists noise, which is for example mainly due to fluctuating friction of the blade or blades on the skin, such noise can also be detected by the method according to the present invention. This might confirm that the wet shaver is still moving over the skin, however without cutting a hair. However, with respect to detect a hair cutting event (hair removing even), a detected noise signal is regarded as a zero signal. Different methods exist to detect such noise. E.g. the difference between the minimum and the maximum of the measured acceleration/rotation values in a given time frame can be compared with a threshold. As soon as the difference exceeds the threshold, noise and subsequently movement is detected.

The detection of hair cutting is repeated when the blade of the wet shaver moves from hair to hair.

The detected sequence of accelerations with different signs results in a significant pattern. This significant pattern is typical for the cutting of a hair. A useful way to detect the pattern is the following:

The output signal of the sensor (measured sensor signal) can e.g. be mathematically compared with predefined patterns. A way how to perform such a comparison, is the use of a dot product of the predefined pattern and a section of the sensor signal. This section is the sensor signal in a defined time interval in the past until the present, e.g. the last 100 ms.

In other words: The first sensor value out of the time interval can be multiplied with the first value of the predefined function, the same happens with the second values and with all the remaining ones. All these products are summed up and result in the dot product. A high value indicates similarity between the sensor signal and the predefined pattern, and a low value indicates different shapes. In this way, information is obtained whether the sensor signal of the defined time interval that is just over, matches a specific pattern or not. In particular, this pattern does not appear, i.e. the dot product is low and stays under a predefined threshold, when the razor is moved on hairless skin without cutting hairs.

Subsequently, different types of information can optionally be extracted, such as the total number of cutting events. This can be done by counting how often the dot product exceeded the beforementioned threshold. Also the rate of hair cutting events per time can be derived. This can be achieved by dividing the number of cut hairs by the length of the time interval in which this happened. Further information can also be obtained such as whether the area that gets shaved in the moment still has hairs. This piece of information can be obtained by comparing the beforementioned hair cutting rate with a threshold. Information can also be obtained about the question whether the hairs are wet or dry or whether the hairs are thin or thick. Thinner hair and also wet hair will cause smaller signals compared to thicker hair, hence resulting in a lower value of the described dot product. The dot product may e.g. exceed lower threshold and stay under a second, higher threshold.

In addition, information about the orientation of the wet shaver as well as information about movements of the wet shaver can also be gained. These two pieces of information can be combined with the aforementioned information about hair cutting. As an example, the velocity of the wet shaver can be combined with the rate of hair cutting events to obtain the density of the hair that gets cut on the currently shaved area.

The current invention also relates to a wet shaver which is able to perform the above-mentioned detection method or parts thereof. The wet shaver according to the proposal might be a manual razor (wet shaver) which does not contain an electrical motor. In order to carry out the above-mentioned detection method, the wet shaver of the current invention comprises an acceleration and/or rotation sensor used and adapted to detect the hair cutting events of a wet shaver in a measured acceleration and/or rotation sensor signal. It is not necessary to attach the sensor on or near the blades of the shaver, which is however also possible. The sensor can be placed at some convenient place at the handle of the wet shaver. So it is not removed when the blade cartridge of the shaver is exchanged.

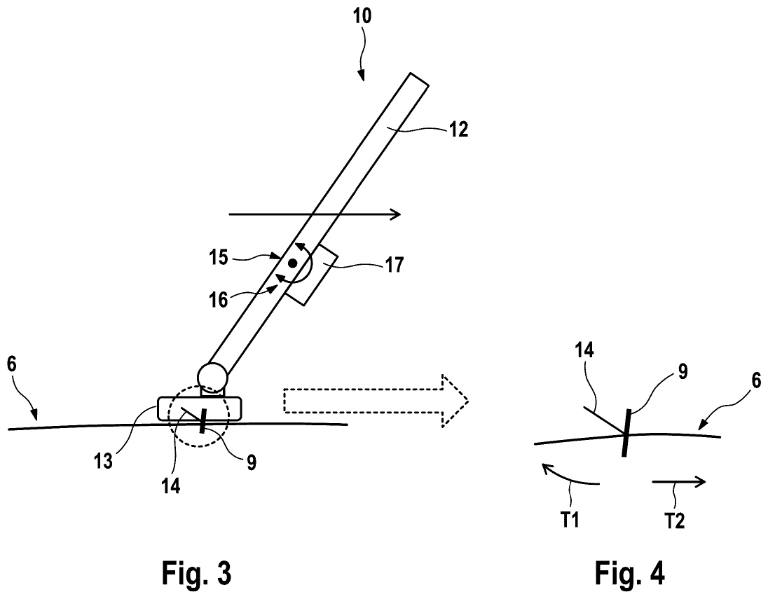

When the blade of the wet shave cuts a hair, as mentioned above, deceleration and/or rotation occurs to the whole wet shaver and the acceleration and/or rotation sensor experiences the same movements. According to a proposed embodiment of the current invention, when the acceleration sensor experiences the deceleration of the wet shaver, the negative acceleration force x (which is perpendicular to the longitudinal axis of the handle of the wet shaver) as well as the negative acceleration force y (which is parallel to the longitudinal axis of the handle of the wet shaver) is detected. When the rotation sensor experiences the rotation of the wet shaver, the torque along the axis perpendicular to x and y is detected. In this way, the sensor detects the acceleration with negative sign and/or rotation of the wet shaver when the blade of the wet shaver is cutting a hair. (This will be further illustrated in the description of the FIGS. 1 and 3.) As soon as the hair is cut, the acceleration or rotation sensor detects the acceleration or torque with positive sign of the wet shaver, and after some relaxation time, the signal goes back to zero (or noise also qualified as zero signal).

In line with the proposal, the sensor can comprise an output, for example a display and/or light emitting diodes (LED), which displays or indicates signals showing the acceleration and/or rotation with negative sign (deceleration) as well as the acceleration and/or rotations with positive sign of the wet shaver.

The detection of hair cutting is repeated when the blade of the wet shaver moves from hair to hair and the detected sequence of deceleration and accelerations and/or rotations rotation with different signs shows a significant pattern which corresponds with cutting hairs. This pattern can be displayed on the output.

The signal of the sensor can be evaluated by many different kinds of electronics. It may consist of just hardware or hard- and software. The sensor and any connected electronics are built up with sufficient bandwidth to make sure that the motions caused by the cutting of the hair are not missed. Preferably, the sensor is connected with an electronic circuit having a processor implemented to extract different types of information from the pattern formed by the detected sequence of accelerations with different signs. (In this text, sensor and the related electronics (electronic circuit) are also denoted as “sensor”.)

The different types of information can include the total number of cutting events, the rate of hair cutting events per time, information indicating whether the area that gets shaved in the moment still has hairs, as well as information about whether the hairs are wet or dry or whether the hairs are thin or thick. The processor can further be used to gain information about the orientation of the wet shaver and/or about movements of the wet shaver.

With reference to FIG. 1, an embodiment of a manual wet shaver 1 of the current invention is described. The wet shaver 1 comprises a handle 2, a hair cutting unit 3 (blade cartridge) which contains a blade 4, and an acceleration sensor 5. The acceleration sensor 5 is mounted on the handle 2 of the wet shaver and is not necessary to be attached on or near the blade 4 of the shaver, e.g. on the blade cartridge or cutting unit 3. The wet shaver 1 moves from left to right on the skin surface 6 (as indicated be the arrow M) and blade 4 encounters and cuts a hair 9. The acceleration sensor 5 experiences together with the wet shaver a deceleration. When the deceleration (acceleration with negative sign) of the wet shaver 1 is experienced, the negative acceleration (with force component x perpendicular to the longitudinal axis of the handle 2 of the wet shaver 1 as well as force component y parallel to the longitudinal axis of the handle 2 of the wet shaver 1) is detected.

FIG. 2 shows an enlarged view of the circled part of FIG. 1 and illustrates the forces which occur when the blade of the wet shaver in FIG. 1 cuts a hair. When the blade 4 contacts and cuts a hair 9, the hair 9 exerts a force FB against the blade 4 as resistance, and a force FH is then applied against hair to overcome the resistance of the hair 9. A deceleration hence occurs.

FIG. 3 shows a sketch of a wet shaver 10 with a rotation sensor 17 (instead of the acceleration sensor 5) during its use according to another proposed embodiment of the invention. The remaining components of the shaver 10 are identical: handle 12, blade cartridge or cutting unit 13, blade 14, and not further described. Due to the force applied by the hair 9 against the blade 14, the whole razor 10 tends to begin a rotation around its center of gravity 15. The bi-directional arrow 16 in the figure exemplifies the rotation which can be detected by the rotation sensor 17. A potential advantage of a rotation sensor is that there is no contribution from the acceleration of gravity. The signal shape of the rotation sensor is qualitatively identical to the one from an acceleration sensor.

In a further embodiment of a proposed wet shaver, the rotation sensor 17 can be combined with the acceleration sensor 5 so that both rotation and acceleration of the wet shaver can be detected and used to gain further information.

FIG. 4 shows an enlarged view of the circled part of FIG. 3 and illustrates the torque T1 which occurs when the blade 14 of the wet shaver 10 in FIG. 3 cuts a hair 9. When the blade 14 contacts and cuts the hair 9, an acceleration of the wet shaver 10 outside of its center of gravity 15 leads to a rotation of the whole razor 10. The torque T1 as a resistance torque from the hair 9 against the blade 14 is detected, and a torque T2 is then applied when the hair 9 is actually cut.

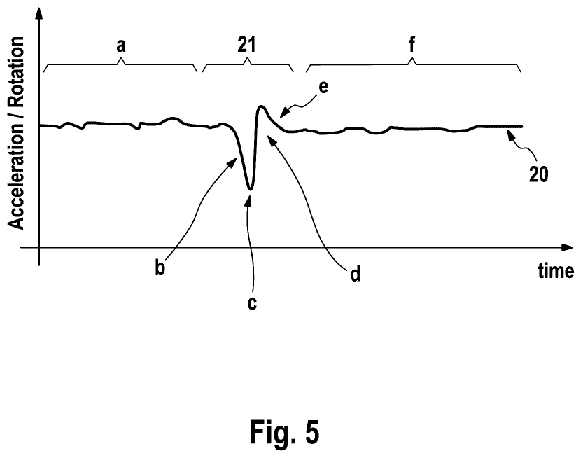

FIG. 5 shows the acceleration or rotation of the wet shaver in the measured sensor signal 20 as function of time in the different phases occurring as described before when cutting a hair 9. The signal for acceleration/deceleration and rotation is qualitatively the same and shown here in arbitrary units.

Phase a is represented by a relatively smooth and horizontal line which shows that the razor is moving on a hair-free region with constant velocity. Only some noise signals are detected which results from small accelerations/rotations due to potentially fluctuating friction of the blade or blades 4, 14 on the skin 6.

When the blade 4, 14 contacts and cuts a hair 9, the signal enters deceleration/rotation phase b when the sensor 5, 17 detects deceleration/rotation due to the hair resistance. The deceleration/rotation phase b continues until the hair 9 is being cut and reaches the lowest point c at the end of the cutting process.

Then an acceleration phase d is detected after the hair 9 is cut. This happens because the mechanical resistance of the hair 9 does not exist anymore and the wet shaver regains its velocity. In case of a detected rotation, the measured signal 20 shows in phase d a rotation in an opposite direction with respect to the phase b, represented by different signs of the measured signal 20 with respect to the zero signal in the phases a and f.

After some relaxation time e, the signal enters a smooth and horizontal phase f, which shows that the razor 1, 10 is again moving an a hair-free region with constant velocity before encountering another hair 9.

The phases b, c, d and e are characteristic for a cutting event 21. Accordingly, by detecting the characteristic form of the cutting event 21 in measured sensor signal (as schematically shown in FIG. 5, a hair cutting event can be identified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for detecting hair cutting events during use of a wet shaver comprising measuring an acceleration and/or rotation sensor signal caused by a cut hair and detecting a specific shape or pattern of said sensor signal.

2. The method of claim 1, wherein when the blade of the wet shaver is cutting a hair, a deceleration of the wet shaver and/or rotation of the wet shaver is detected in a measured acceleration and/or rotation sensor signal compared to a zero signal indicating no acceleration or deceleration and/or rotation of the wet shaver, and after the hair has been cut, an acceleration and/or rotation opposite to the first one of the wet shaver is detected in said measured sensor signal, and after some relaxation time, an acceleration and/or rotation signal, which goes back to said zero signal, is detected in said measured sensor signal.

3. The method of claim 2, wherein the zero signal detected comprises noise signals due to fluctuating friction of the blade or blades on the skin.

4. The method of claim 1, wherein noise in the measured sensor signal is detected for identifying movement of the wet shaver over skin.

5. The method of claim 1, wherein the measured sensor signal is mathematically compared with a predefined pattern by using a dot product of the predefined pattern and a section of the measured sensor signal within a defined time interval, wherein the first sensor value out of the defined time interval is multiplied with the first value of the predefined pattern, and the same is carried out with the second and all the remaining values, and all these products are then summed up and form the dot product, wherein information is obtained whether the measured sensor signal in the defined time interval matches with the predefined patterns by determining whether the dot product reaches a predefined threshold.

6. The method of claim 5, wherein additional different types of information be extracted comprises:
the total number of cutting events by counting how often the dot product exceeded the threshold, or
the rate of hair cutting events per time by dividing the number of cut hairs by the length of the time interval in which this happened, or
information indicating whether the area that gets shaved in the moment still has hairs by comparing the hair cutting rate with a threshold, or
information about whether the hairs are wet or dry or whether the hairs are thin or thick.

7. A wet shaver with a hair cutting unit comprising: an acceleration and/or rotation sensor used to detect the hair cutting events of the wet shaver, wherein the acceleration and/or rotation sensor is adapted to detect in a measured acceleration and/or rotation sensor signal the shape or pattern of the signal.

8. The wet shaver according to claim 7, wherein the acceleration and/or rotation sensor is adapted to detect in a measured acceleration and/or rotation sensor signal:
a deceleration of the wet shaver and/or rotation of the wet shaver compared to a zero signal indicating no acceleration or deceleration and/or rotation of the wet shaver,
after the hair has been cut, an acceleration and/or rotation opposite to the first one of the wet shaver, and
after some relaxation time, an acceleration and/or rotation signal, which goes back to said zero signal.

9. The wet shaver of claim 7, wherein when the acceleration and/or rotation sensor experiences acceleration and/or torque with positive or negative sign of the wet shaver.

10. The wet shaver of claim 7, wherein the acceleration and/or rotation sensor comprises an output which displays signals showing the acceleration and/or rotation of the wet shaver with a negative sign or with a positive sign.

11. The wet shaver of claim 7, wherein the acceleration and/or rotation sensor comprises an output which displays signals showing the acceleration and/or rotation of the wet shaver with a negative sign and with a positive sign.

12. The wet shaver of claim 7, wherein the acceleration and/or rotation sensor is provided at a handle of the wet shaver.

13. The wet shaver of claim 8, wherein the acceleration and/or rotation sensor is provided at a handle of the wet shaver.

14. The wet shaver of claim 9, wherein the acceleration and/or rotation sensor is provided at a handle of the wet shaver.

15. The wet shaver of claim 7, wherein the acceleration and/or rotation sensor is adapted to repeat the detection of hair cutting when the blade of the wet shaver moves from hair to hair and the detected sequence of deceleration and acceleration and/or rotation with different signs shows a significant pattern which corresponds with skin with cutting hairs.

16. The wet shaver of claim 8, wherein the acceleration and/or rotation sensor is adapted to repeat the detection of hair cutting when the blade of the wet shaver moves from hair to hair and the detected sequence of deceleration and acceleration and/or rotation with different signs shows a significant pattern which corresponds with skin with cutting hairs.

17. The wet shaver of claim 9, wherein the acceleration and/or rotation sensor is adapted to repeat the detection of hair cutting when the blade of the wet shaver moves from hair to hair and the detected sequence of deceleration and acceleration and/or rotation with different signs shows a significant pattern which corresponds with skin with cutting hairs.

18. The wet shaver of claim 7, wherein the acceleration and/or rotation sensor is connected with an electronic circuit having a processor implemented to extract different types of information from the pattern formed by the detected sequence of deceleration and acceleration and/or rotation with different signs, wherein the different types of information include the total number of cutting events, the rate of hair cutting events per time, information indicating whether the area that gets shaved in the moment still has hairs, as well as information about whether the hairs are wet or dry or whether the hairs are thin or thick.

19. The wet shaver of claim 8, wherein the acceleration and/or rotation sensor is connected with an electronic circuit having a processor implemented to extract different types of information from the pattern formed by the detected sequence of deceleration and acceleration and/or rotation with different signs, wherein the different types of information include the total number of cutting events, the rate of hair cutting events per time, information indicating whether the area that gets shaved in the moment still has hairs, as well as information about whether the hairs are wet or dry or whether the hairs are thin or thick.

20. The wet shaver of claim 7, wherein the processor implemented is further used to gain information about the orientation of the wet shaver and/or about the movement of the wet shaver.
